(19) United States
(12) Patent Application Publication
(10) Pub. No.: US 2025/0033937 A1
(43) Pub. Date: Jan. 30, 2025

(54) VEHICLE CRANE COMPRISING A MOUNTING FRAMEWORK AND METHOD FOR MOUNTING A BRACING APPARATUS ON A TELESCOPING JIB

(71) Applicant: Tadano Demag GmbH, Zweibrücken (DE)

(72) Inventors: Martin Bauer, Steinwenden (DE); Simon Schneider, Martinshöhe (DE); Traugott Feß, Bechhofen (DE); Andreas Lang, Langwieden (DE); Matthias Roth, Waldmohr (DE)

(21) Appl. No.: 18/784,709

(22) Filed: Jul. 25, 2024

(30) Foreign Application Priority Data
Jul. 26, 2023 (DE) 102023119813.0

(51) Int. Cl. B66C 23/42; B66C 23/82

(52) U.S. Cl. CPC B66C 23/42; B66C 23/825

(57) ABSTRACT

A vehicle crane comprising a mounting framework, where at least one bracing arm of a bracing apparatus of the vehicle crane can be temporarily stored on the mounting framework. The mounting framework comprises at least one displaceable sliding frame and a single bracing arm can be temporarily stored on the sliding frame. The mounting framework is arranged in extension of a lower carriage of the vehicle crane and completely behind the lower carriage and is fastened to the lower carriage to provide a vehicle crane with an optimized temporary storage option for the bracing apparatus on the lower carriage. Also provided is a method for mounting a bracing apparatus on a telescoping jib of a vehicle crane.

### CROSS REFERENCE TO RELATED APPLICATION

The present application claims the priority benefits of German application no. 10 2023 119 813.0, filed on Jul. 26, 2023.

### BACKGROUND AND FIELD OF THE INVENTION

The invention relates to a vehicle crane comprising a mounting framework, wherein at least one bracing arm of a bracing apparatus of the vehicle crane can be temporarily stored on the mounting framework, the mounting framework comprises at least one displaceable sliding frame, on which a single bracing arm can be temporarily stored. The invention also relates to a method for mounting a bracing apparatus on a telescoping jib of a vehicle crane.

German patent specification DE 10 2021 111 922 B3 discloses a mounting and transport framework for two bracing arms that can be mounted onto a telescoping jib of a vehicle crane in order to increase the load-bearing capacity. The bracing arms are mounted on the same mounting and transport framework for transport on a low loader, for transport between the low loader and the vehicle crane and for preparation for mounting on the vehicle crane. The mounting and transport framework consists substantially of a base frame having a left frame part with support legs for receiving a first bracing arm and having a right frame part with support legs for receiving a second bracing arm. The right and left frame parts are arranged on the base frame so as to be displaceable relative to one another in order to move them as required between a narrow transport position and a wide mounting position and vice versa. For transport on the low loader, the mounting and transport framework is placed together with the supported first and second bracing arms on the low loader and the frame parts are located in the narrow transport position. In order to mount the first bracing arm and the second bracing arm onto the telescoping jib of the vehicle crane, the mounting and transport framework is lifted together with the two bracing arms by the telescoping crane onto a mounting surface on a lower carriage of the vehicle crane and is bolted at this location. In one variant, the two bracing arms are only then moved apart from one another from the narrow transport position to the wide mounting position. Subsequently, the telescoping jib is luffed down and is introduced between the two bracing arms, the two bracing arms are fastened individually to the telescoping jib and are then each detached from the mounting and transport framework. In a typical manner, the telescoping jib is then erected and the bracing arms are splayed and braced. During operation of the vehicle crane, the mounting and transport framework can remain on the lower carriage and, where required, can be used as a storage area for the bracing arms.

European patent specification EP 2 248 754 B1 discloses a further vehicle crane comprising bracing arms which can be mounted by the vehicle crane itself. In this case, the two bracing arms are also transported on a separate low loader to a deployment site of the vehicle crane. The bracing arms are connected at one end via a u-shaped holding frame to form a structural unit and are provided at their opposite ends in each case with foot supports which can be dismounted and foot supports which can be varied in length. In order to mount the bracing arms on a telescoping jib of the vehicle crane, the structural unit is raised from the low loader by means of the telescoping jib of the vehicle crane and is placed behind a lower carriage of the vehicle crane in extension of the lower carriage. In this case, the foot supports which can be varied in length rest on a ground surface and the foot supports which can be dismounted rest in the region of the u-shaped holding frame on the lower carriage. Alternatively, the structural unit can be placed with its foot supports which can be varied in length and its foot supports which can be dismounted, at the front on the lower carriage. In this case also, the bracing arms are fastened to the telescoping jib via the holding frame after the telescoping jib has been introduced between the two bracing arms, and the foot supports which can be dismounted are dismounted from the holding frame. The foot supports which can be varied in length remain on the bracing arms.

Furthermore, European patent specification EP 1 342 692 B1 discloses a further vehicle crane, of which both bracing arms are again transported separately from the vehicle crane on a low loader to the deployment site. Upon arrival at the deployment site, the bracing arms are then lifted by means of the vehicle crane from the low loader and are temporarily stored on a lower carriage of the vehicle crane. For this purpose, four leg-like brackets are arranged on the lower carriage, on which brackets the two bracing arms of the bracing apparatus are placed. Subsequently, a telescoping jib of the vehicle crane is luffed down to a substantially horizontal receiving position between the two bracing arms and the bracing arms are coupled to the telescoping jib.

### SUMMARY OF THE INVENTION

The present invention provides a vehicle crane comprising a mounting framework with an optimized temporary storage option for a bracing apparatus and provides an optimized method for mounting a bracing apparatus on a telescoping jib of a vehicle crane.

In accordance with an embodiment of the invention, in the case of a vehicle crane comprising a mounting framework, wherein at least one bracing arm of a bracing apparatus of the vehicle crane can be temporarily stored on the mounting framework, the mounting framework comprises at least one displaceable sliding frame, a single bracing arm can be temporarily stored on the sliding frame, an optimized temporary storage option for a bracing apparatus is achieved by virtue of the fact that the mounting framework is arranged in extension of a lower carriage of the vehicle crane and completely behind the lower carriage and is fastened to the lower carriage at the front or rear. Therefore, the mounting framework is held on the lower carriage i.e. at a front or rear side of the lower carriage and is oriented with respect thereto and is not supported on a surface or top side of the lower carriage. The mounting framework is supported at the front or rear side of the lower carriage via lugs or brackets, attached thereto, of a single-shear, preferably multi-shear, bolt connection. This front or rear side of the lower carriage is typically oriented vertically. In connection with the present invention, going completely behind the lower carriage in the longitudinal direction of the lower carriage is understood to mean at the front or rear behind the lower carriage.

In this case, provision is made in an advantageous manner that the mounting framework is supported on a ground surface via support legs at a rear end remote from the lower carriage and is coupled, at an opposite front end, to a rear end of the lower carriage.

In a structurally preferred embodiment, provision is made that the mounting framework comprises a base frame, an intermediate frame, a first sliding frame and a second sliding frame, the intermediate frame is arranged on the base frame and the two sliding frames are arranged on the intermediate frame in such a manner as to be displaceable independently of one another.

In an advantageous manner, provision is made that, starting from a completely retracted receiving position, the first sliding frame can be displaced only in a first direction and can be displaced back again and, starting from a completely retracted receiving position, the second sliding frame can be displaced in a second direction opposite to the first direction and can be displaced back again.

Typically, the vehicle crane comprises a lower carriage, a superstructure and a telescoping jib. The telescoping jib comprises a basic box having retractable and extendible inner boxes, wherein a bracing apparatus having a first bracing arm and a second bracing arm can be attached to the telescoping jib and, for attachment purposes, the first bracing arm and the second bracing arm can be placed on the mounting framework one after the other.

In accordance with an aspect of the invention, an optimized method for mounting a bracing apparatus on a telescoping jib of a vehicle crane together with an optimized temporary storage option for a bracing apparatus are achieved by the following steps: providing a first transport unit having a mounting framework, received thereon, in the region of the vehicle crane; raising the mounting framework from the first transport unit by means of the vehicle crane in relation to its load hook; positioning the mounting framework in extension of a lower carriage of the vehicle crane; fastening the mounting framework to the lower carriage and completely behind the lower carriage and detaching the vehicle crane in relation to its load hook from the mounting framework; providing a second transport unit having the bracing apparatus, which is received thereon and includes a first bracing arm and a second bracing arm, in the region of the vehicle crane; raising the first bracing arm from the second transport unit by means of the vehicle crane in relation to its load hook; lowering and placing the first bracing arm of the bracing apparatus onto a first sliding frame of the mounting framework by means of the vehicle crane; displacing the first sliding frame in a first direction of a mounting direction from a retracted receiving position to a laterally extended lowering position in relation to its load hook; raising the second bracing arm from the second transport unit by means of the vehicle crane; lowering and placing the second bracing arm of the bracing apparatus onto a second sliding frame of the mounting framework by means of the vehicle crane in relation to its load hook; displacing the second sliding frame in each case in a second direction of the mounting direction from a retracted receiving position to a laterally extended lowering position; luffing the telescoping jib down between the first bracing arm and the second bracing arm; displacing the first sliding frame and the second sliding frame in each case in the mounting direction from its lowering position to a central fastening position, in which in each case a fastening frame of the first bracing arm and the second bracing arm abut against a basic box of the telescoping jib; and fastening the first bracing arm and the second bracing arm in each case with its fastening frame to the basic box.

An exemplified embodiment of the invention will be explained in greater detail with reference to the following description.

### BRIEF DESCRIPTION OF THE DRAWINGS

FIG. 1 shows a perspective view of a vehicle crane system consisting of a vehicle crane and two transport units;

FIG. 2 shows a perspective view of the vehicle crane and the first transport unit shown in FIG. 1 with a raised mounting framework;

FIG. 3 shows a perspective view of the vehicle crane shown in FIG. 2 with an attached mounting framework;

FIG. 4 shows a perspective detailed view of the mounting framework on the vehicle crane shown in FIG. 3;

FIG. 5 shows a perspective view of the second transport unit shown in FIG. 1;

FIG. 6 shows a perspective view of the vehicle crane and the second transport unit shown in FIG. 1 with a raised first bracing arm;

FIG. 7 shows a perspective view of the vehicle crane shown in FIG. 5 with the first bracing arm on the attached mounting framework and with a raised second bracing arm;

FIG. 8 shows a perspective detailed view of the mounting framework shown in FIG. 4 with a first bracing arm and a second bracing arm;

FIG. 9 shows a perspective side view of the vehicle crane with a lowered telescoping jib;

FIG. 10 shows an enlarged section of a plan view of the first bracing arm and the second bracing arm shown in FIG. 8 in each case in the lowering position;

FIG. 11 shows an enlarged section shown in FIG. 10 with the first bracing arm and the second bracing arm shown in each case in the fastening position; and

FIG. 12 shows a perspective view of the vehicle crane with two attached and braced bracing arms.

### DESCRIPTION OF THE PREFERRED EMBODIMENTS

Firstly, a method for attaching a first bracing arm 9a and a second bracing arm 9b of a bracing apparatus 9 to a telescoping jib 6 of a vehicle crane 2 and secondly a mounting framework 11, used for this purpose, are described in greater detail hereinafter by reference to the figures.

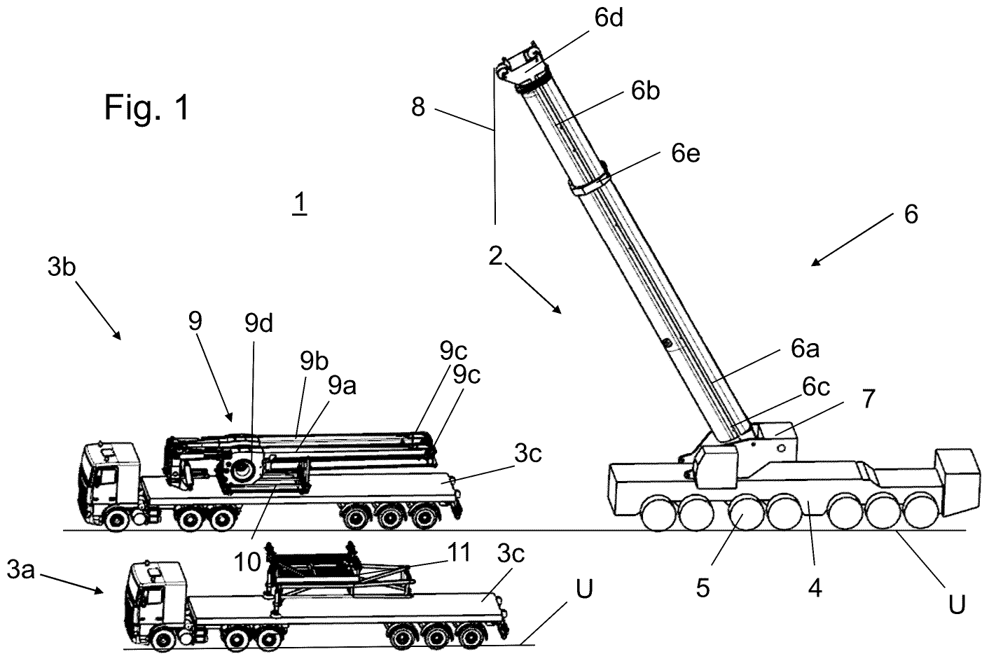

FIG. 1 shows a perspective view of a vehicle crane system 1 having a vehicle crane 2, having a first transport unit 3a and having a second transport unit 3b which are each placed on a ground surface U. The first and second transport units 3a, 3b are typically designed as trailer trucks with trailers. Such vehicle crane systems 1 are required because, by reason of the very heavy weight of the vehicle crane 2 per se, the vehicle crane 2 usually has to be driven to its respective deployment site partially disassembled in order to be able to comply with the maximum values specified for the public road network with regard to axle load and vehicle weight. Further attachments of the vehicle crane 2, such as e.g. a bracing apparatus 9 for increasing the load-bearing capacity of the vehicle crane 2, a telescoping jib extension, an entire telescoping jib 6 or counterweights, are thus frequently transported separately on transport units 3a, 3b.

The vehicle crane 2 which can travel on public roads typically has a multi-axle lower carriage 4 with pneumatic-tire wheels 5. Arranged on the lower carriage 4 is a superstructure 7 which carries the telescoping jib 6 and which can be pivoted relative to the lower carriage 4 about a vertical axis. The telescoping jib 6 has a basic box 6a which is articulated to the superstructure 7 so as to be able to be luffed about a horizontal axis and in the region of a telescoping jib foot 6c of the telescoping jib 6, and which receives a plurality of inner boxes 6b which can be retracted and extended linearly and of which only a first inner box 6b is shown. A lifting cable 8, from which a load-picking up means, such as e.g. a load hook with a lower block for a cable reeving arrangement, is suspended, extends over a telescoping jib head 6d which is arranged at a free end of the telescoping jib 6, in particular on an innermost one of the inner boxes 6b.

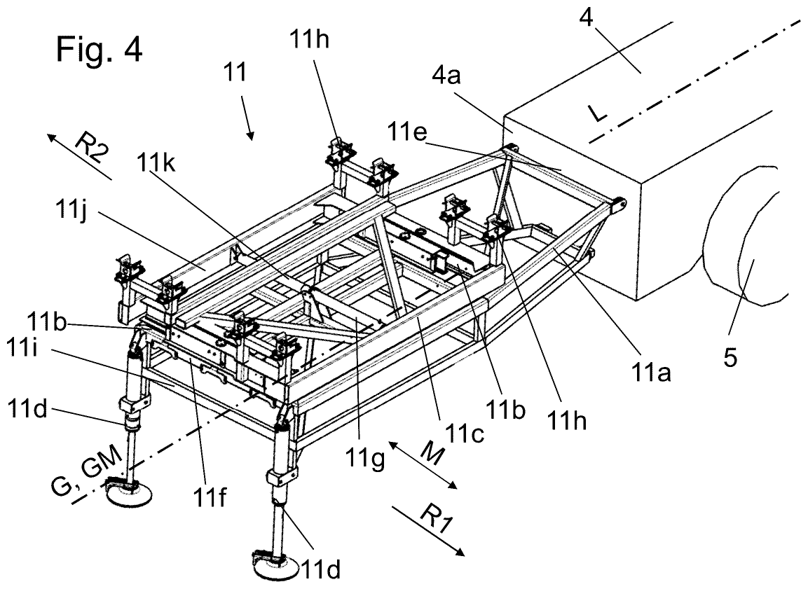

The two transport units 3a, 3b each have a loading surface 3c which is typically part of a low loader. A mounting framework 11 is transported by the first transport unit 3a. The mounting framework 11 has the function of an auxiliary framework which is used during mounting of the first and second bracing arms 9a, 9b onto the telescoping jib 6. The mounting framework 11 consists substantially of a lower base frame 11a, preferably in the form of a lattice mast portion, a central intermediate frame 11b and an upper first right sliding frame 11c and an upper second left sliding frame 11j (see FIG. 4) and serves to extend the lower carriage 4 in order to provide a temporary storage option for the two bracing arms 9a, 9b.

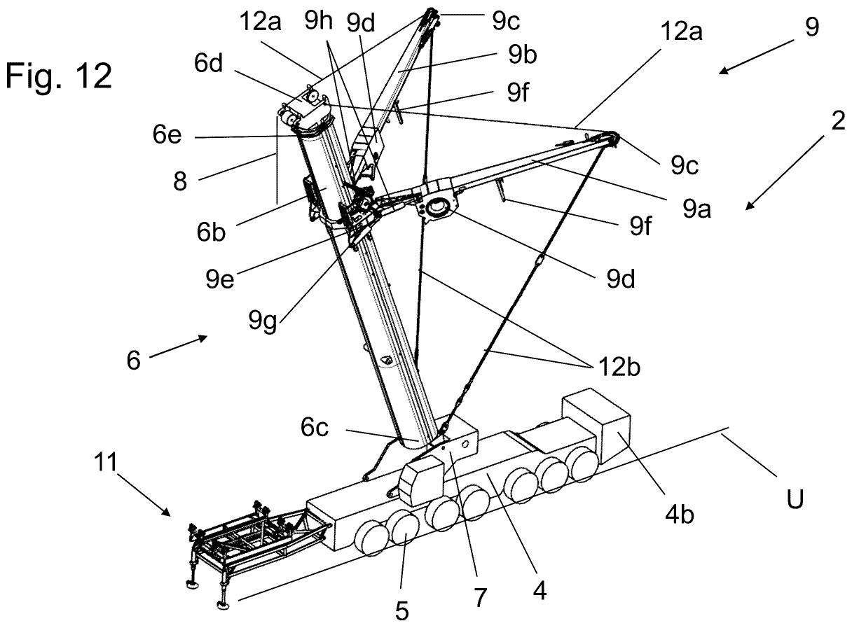

A bracing apparatus 9 for the telescoping jib 6 is transported on the loading surface 3c of the second transport unit 3b as an attachment for the vehicle crane 2. Such bracing apparatuses 9 are known for achieving an increase in the load-bearing capacity of the vehicle crane 2, provide rear and lateral bracing of the telescoping jib 6 and reduce elastic sagging of the telescoping jib 6 during operation of the vehicle crane 2. For this purpose, the bracing apparatus 9 is typically attached to the basic box 6a of the telescoping jib 6 and, in one embodiment variant, in the region of its upper collar 6e. The bracing apparatus 9 consists of a first bracing arm 9a and a second bracing arm 9b which are coupled to the telescoping jib 6 and can be splayed rearwards and in a v-shape to an operating position (see FIG. 12). It is also evident that the first and second bracing arms 9a, 9b each have, in a central and lower region, a tensioning mechanism 9d in the form of a cable winch in order to tension tensioning means such as bracing cables 12a and bracing rods 12b (see FIG. 12) of an associated bracing arrangement in an appropriate manner. On the second transport unit 3b, the two bracing arms 9a, 9b are in a horizontal, mutually parallel and spaced-apart transport position. In the transport position, the two bracing arms 9a, 9b are oriented with respect to their longitudinal directions substantially in parallel with a longitudinal direction of the second transport unit 3b. Moreover, the two bracing arms 9a, 9b are placed as closely as possible to one another on the loading surface 3c such that they preferably do not protrude laterally beyond the loading surface. In a mounting position of the two bracing arms 9a, 9b on the telescoping jib 6, the two bracing arms 9a, 9b are arranged next to one another, wherein the distance between the two bracing arms 9a, 9b is greater than in the transport position and is adapted to the width of the telescoping jib 6. The two bracing arms 9a, 9b are placed on the loading surface 3c in a common transport framework 10, adapted to the geometry of the two bracing arms 9a, 9b, and are secured at this location for transport purposes. The transport framework 10 is formed in one piece for both bracing arms 9a, 9b.

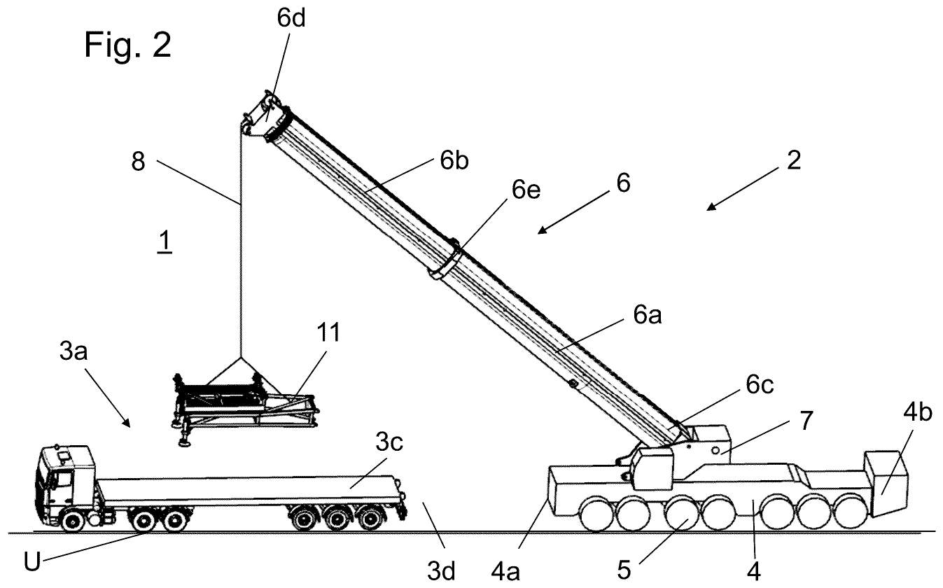

FIG. 2 illustrates a further three-dimensional view of the vehicle crane 2 and the first transport unit 3a shown in FIG. 1. At the beginning of a so-called rigging procedure for attaching the first bracing arm 9a and the second bracing arm 9b to the telescoping jib 6, the first transport unit 3a is oriented with respect to the vehicle crane 2 in such a way that the first transport unit 3a is located with its longitudinal direction in extension of the vehicle crane 2 in relation to its longitudinal direction. In this case, a distance remains between the vehicle crane 2 and the first transport unit 3a. Moreover, in this case a rear end 4a of the lower carriage 4, which is opposite to a driver's cabin 4b of the vehicle crane 2, and a rear end 3d of the second transport unit 3b face one another, so that the loading surface 3c of the first transport unit 3a faces the vehicle crane 2. Alternatively, the vehicle crane 2 can be oriented in a corresponding manner with respect to the first transport unit 3a. In a next rigging step, after orientation the mounting framework 11 is raised from the loading surface 3c by means of the vehicle crane 2 so that the first transport unit 3a can drive away.

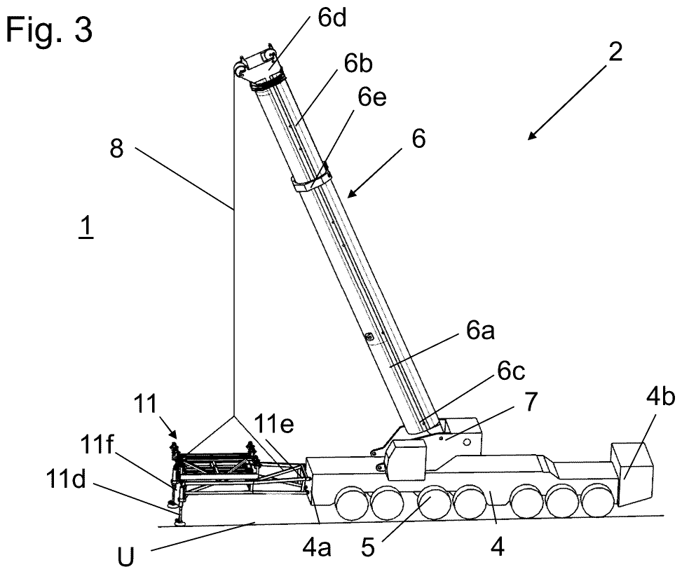

In a next step, as shown in FIG. 3, which shows a perspective view of the vehicle crane 2 shown in FIG. 2 with an attached mounting framework 11, it is evident that the mounting framework 11 has been moved to a fastening position onto the rear end 4a of the lower carriage 4 by means of the vehicle crane 2. In this coupling position, the front end Ile of the mounting framework 11 abuts against the rear end 4a of the lower carriage 4. The mounting framework 11 has also been lowered so far by the vehicle crane 2 that a top side of the mounting framework 11 is approximately at a common level with a surface of the lower carriage 4, and thus a receiving surface for the two bracing arms 9a, 9b on the lower carriage 4 has been extended with the mounting framework 11. In this coupling position, the mounting framework 11 is then fastened, in particular bolted, to the lower carriage 4. Support legs 11d which can be varied in length are also arranged at the opposite, rear end 11f of the mounting framework 11 in order to support the free rear end 11f of the mounting framework 11 on the ground surface U. Subsequently, the vehicle crane 2 or its lifting cable 8 is detached from the mounting framework 11 and is available for the further mounting steps.

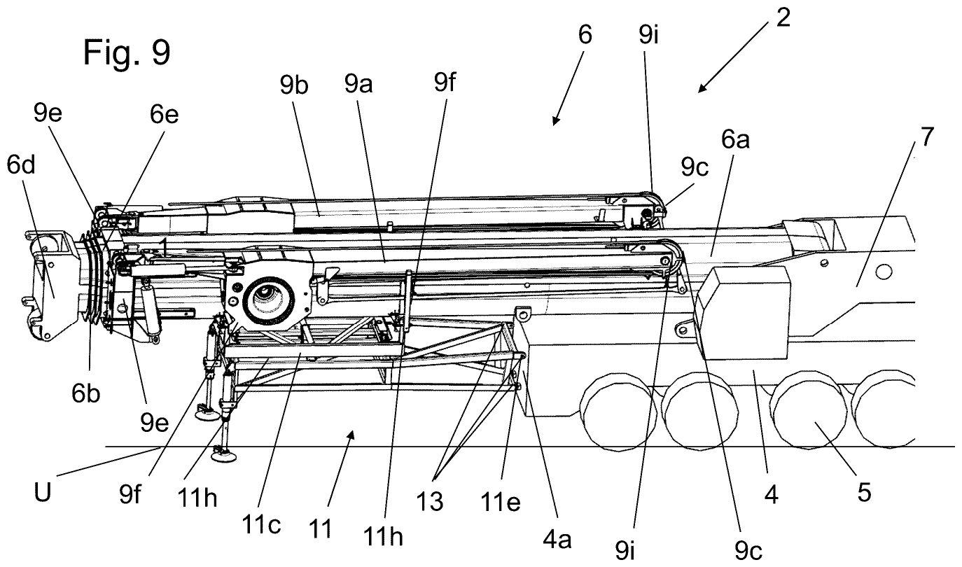

FIG. 4 shows a perspective detailed view of the mounting framework 11 shown in FIG. 3 which is already fastened to the lower carriage 4 of the vehicle crane 2. In contrast to FIG. 3, in a further rigging step the lifting cable 8 has been detached from the mounting framework 11. The structure of the mounting framework 11 will be explained in greater detail hereinafter by reference to FIG. 4. The mounting framework 11 consists substantially of a lower base frame 11a, a central intermediate frame 11b, a first upper sliding frame 11c and a second upper sliding frame 11j and support legs 11d. The base frame 11a has a latticework or frame structure and can have a triangular, quadrangular or polygonal cross-section. In the present case, the base frame begins at its rear end 11f with a flat rectangular cross-section which, after continuing constantly over about two thirds of the length of the mounting framework 11, tapers to a symmetrical trapezoidal cross-section. The base frame 11a has substantially the form of a flat cuboid. The base frame 11a also has a longitudinal direction G which, in the coupling position of the mounting framework 11, is oriented in extension with respect to a longitudinal direction L of the lower carriage 4. The longitudinal direction G is thus indicated centrally in relation to the symmetrical base frame 11a in FIG. 4 such that it also corresponds to a centre line GM of the mounting framework 11. The length of the base frame 11a is selected such that the first and second bracing arms 9a, 9b can be placed on the mounting framework 11 such that the vehicle crane 2 with its lowered telescoping jib 6, in particular with its basic box 6a, can move next to the bracing arms 9a, 9b, which are to be picked up in each case, or between the first and second picked-up bracing arm 9a, 9b (see FIG. 9). An intermediate frame 11b is fastened, preferably welded or screwed, to the base frame 11a in a positionally fixed manner, said intermediate frame carrying the first and second sliding frame 11c, 11j each with two support elements 11h, which are spaced apart from one another in the longitudinal direction G, for one of the two bracing arms 9a, 9b.

The intermediate frame 11b is designed as two intermediate frame parts which are spaced apart from one another as seen in the longitudinal direction G of the mounting framework 11. Each intermediate frame part is designed as a double telescoping slide-out or double telescoping rail. For this purpose, each intermediate frame part has a central beam which is fastened to the base frame 11a. Telescoping slide-outs for the second sliding frame 11j, which is u-shaped when seen in plan view, are fastened to the two central beams on the inner sides facing one another. Further telescoping slide-outs for the first sliding frame 11c, which is rectangular when seen in plan view, are fastened to the outer sides of the central supports facing away from one another.

The base frame 11a, the intermediate frame 11b and the two sliding frames 11c and 11j are fixedly connected to one another to form a structural unit. On each of the two sliding frames 11c and 11j, four leg-like support elements 11h are arranged in the corner points of an imaginary rectangle, two of which support elements are spaced apart from one another in the longitudinal direction G and are designed in such a way that one of the two bracing arms 9a, 9b can be placed with their legs 9f (see FIG. 9) securely thereon. The leg-like support elements 11h of the mounting framework 11 are adapted in a corresponding manner to the geometry of the legs 9f of the bracing arms 9a, 9.

Each of the two sliding frames 11c, 11j can be displaced horizontally, linearly, in a mounting direction M and, starting from the center line GM, in a first direction R1 or in a second direction R2 and relative to the base frame 11a and along the intermediate frame 11b in order to be able to orient or space apart the bracing arm 9a, 9b, which is received thereby, in a lateral manner with respect to the picking-up telescoping jib 6. In relation to the base frame 11a, the first sliding frame 11c can be moved from a completely retracted receiving position in the region of the center line GM to lowering position, which is extended laterally in the first direction R1 completely to the right, and a central fastening position. Also, in relation to the base frame 11a, the second sliding frame 11j can be moved from a completely retracted receiving position in the region of the center line GM to a lowering position, which is extended laterally in the second direction R2, completely to the left, and a central fastening position. In the retracted receiving position, the sliding frame 11c and the support elements 11h are oriented in an offset manner with respect to the center line GM to the right and left respectively and so an inner edge of the first and second sliding frame 11c, 11j lies in the region of the center line GM. For the displacement movement of the first sliding frame 11c and the second sliding frame 11j, in each case a first hydraulic cylinder 11g and a second hydraulic cylinder 11k are arranged between the base frame 11a and the sliding frame 11c, 11j respectively. It is obvious that the first and second hydraulic cylinder 11g, 11k can each be replaced by any other suitable drive or combinations thereof. The allocated hydraulic cylinders 11g, 11k allow the sliding frames 11c, 11j to be displaced independently of one another. The first sliding frame 11c can be displaced, starting from the receiving position adjoining the center line GM, exclusively only to the right in relation to the intermediate frame 11b and as seen in the direction of the vehicle crane 2. This means that only the right, first bracing arm 9a can be displaced from the first sliding frame 11c with the first intermediate frame 11b on the base frame 11a to the lowering and fastening positions, required for mounting, on the right side of the basic box 6a and thus in the first direction R1. In the inner receiving position, one of the two bracing arms 9a, 9b, in the present case the right and first bracing arm 9a, is placed onto the mounting framework 11 by the vehicle crane 2. In the lowering position, the bracing arm 9a, 9b to be mounted is moved laterally outwards or to the right on the outside to such an extent that the telescoping jib 6 can be lowered next to or at the level of the bracing arm 9a, 9b without colliding with the respective bracing arm 9a, 9b. From the lowering position, the bracing arm 9a, 9b can then be displaced in the direction of the telescoping jib 6 to the fastening position, so that the bracing arm 9a, 9b abuts against the basic box 6a and can be fastened at that location. Moreover, the first and second sliding frame 11c, 11j can adjoin one another in the respectively inner receiving position.

The same applies to the second sliding frame 11j and the second bracing arm 9b. A displacement movement is then effected correspondingly in the second direction R2 and to the left. The first direction R1 and the second direction R2 are opposite to one another. The two sliding frames 11c, 11j can be moved synchronously or one after the other in terms of time. The same applies to the fastening of the bracing arms 9a, 9b to the basic box 6a.

In addition, it is evident in FIG. 4 that a pair of support legs 11d which can be varied in length in the vertical direction are arranged at the rear end 11f. The two support legs 11d are opposite one another and spaced apart from one another in relation to the longitudinal direction G. The two support legs 11d together with an allocated holding frame 11i also form a structural unit which can be fastened to respectively suitable base frames 11a. The support legs 11d are preferably an integral part of the mounting framework 11.

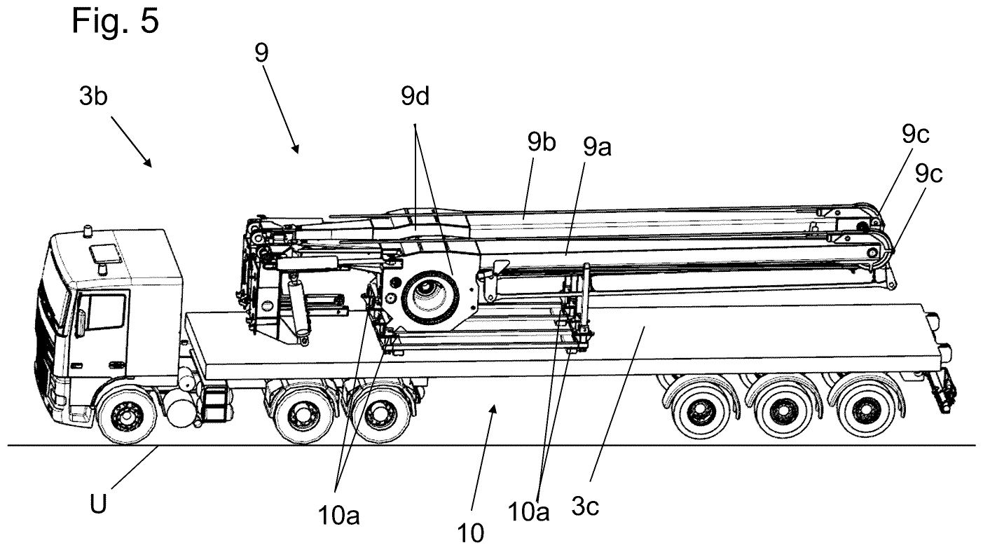

FIG. 5 shows a perspective view of the second transport unit 3b shown in FIG. 1. It is evident that the single and u-shaped transport framework 10 rests with the two received bracing arms 9a, 9b on the loading surface 3c. The transport framework 10 has four leg-like transport supports 10a in each of the corner points of an imaginary rectangle for receiving the first bracing arm 9a and the second bracing arm 9b, two of which transport supports are spaced apart from one another in the longitudinal direction of the loading surface 3c and are designed such that one of the two bracing arms 9a, 9b can be placed with its legs 9f (see FIG. 9) securely thereon. The leg-like transport supports 10a of the transport framework 11 are adapted in a corresponding manner to the geometry of the legs 9f of the bracing arms 9a, 9.

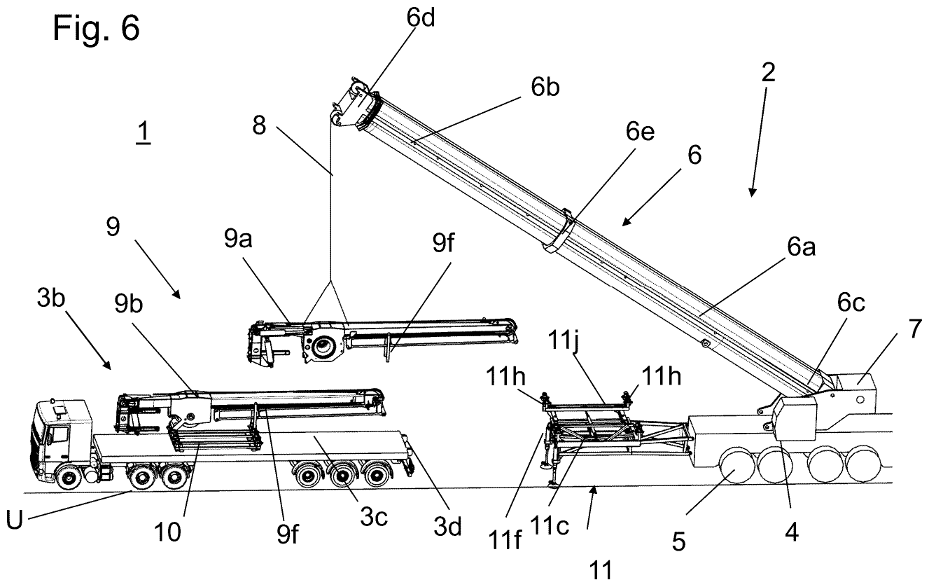

After the mounting framework 11 has been fastened to the lower carriage 4, one of the two bracing arms 9a, 9b is transported in a next rigging step. For this purpose, it is apparent from FIG. 6, which shows a perspective view of the vehicle crane 2 and the second transport unit 3b shown in FIG. 1 with a raised first bracing arm 9a, that the second transport unit 3b is initially oriented with respect to the vehicle crane 2 in such a way that the second transport unit 3b is positioned with its longitudinal direction in extension of the vehicle crane 2 in relation to its longitudinal direction. As described above in respect of FIG. 2, in this case a distance remains between the vehicle crane 2 and the second transport unit 3b. Moreover, in this case the rear end 11f of the mounting framework 11 and the rear end 3d of the second transport unit 3b face one another such that the loading surface 3c of the second transport unit 3b faces the vehicle crane 2. Alternatively, the vehicle crane 2 can be oriented in a corresponding manner with the second transport unit 3b. After the orientation, in a next rigging step only the first bracing arm 9a of the two bracing arms 9a, 9b is raised from the second transport unit 3b and the transport framework 10 by means of the vehicle crane 2. The first bracing arm 9a is raised in a typical manner by winding up the lifting cable 8, by luffing up the telescoping jib 6 or extending an inner box 6b, as well as combinations thereof. Prior to the raising, the lifting cable 8 has typically been connected to the first bracing arm 9a. In this case, the transport framework part 10 remains on the loading surface 3c of the second transport unit 3b. The second bracing arm 9b remains on the transport framework 10 on the second transport unit 3b.

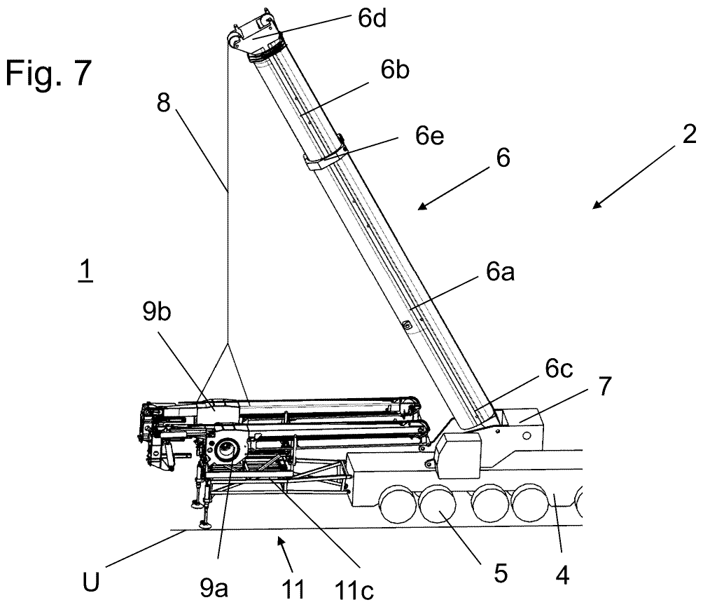

FIG. 7 illustrates a perspective view of the vehicle crane 2 shown in FIG. 6 in a subsequent rigging state. It is evident that the first bracing arm 9a has already been placed onto the sliding frame 11c of the mounting framework 11, in particular onto the four support elements 11h present at that location. For this purpose, the first sliding frame 11c was located in the inner receiving position and was then pushed to the right outwards in the first direction R1 to the lowering position (see FIG. 4). Fundamentally, it is also possible that the first sliding frame 11c still remains in the receiving position because there is sufficient space that the second bracing arm 9b is placed next to it on the second sliding frame 11j in its receiving position. Then, the second bracing arm 9b is picked up from second transport unit 3b and is moved by the vehicle crane 2 in the direction of the mounting framework 11. The second bracing arm 9b is suspended from the vehicle crane 2 above the second sliding frame 11j (see FIG. 4). In anticipation of the second bracing arm 9b, the second sliding frame 11j is located in its inner receiving position.

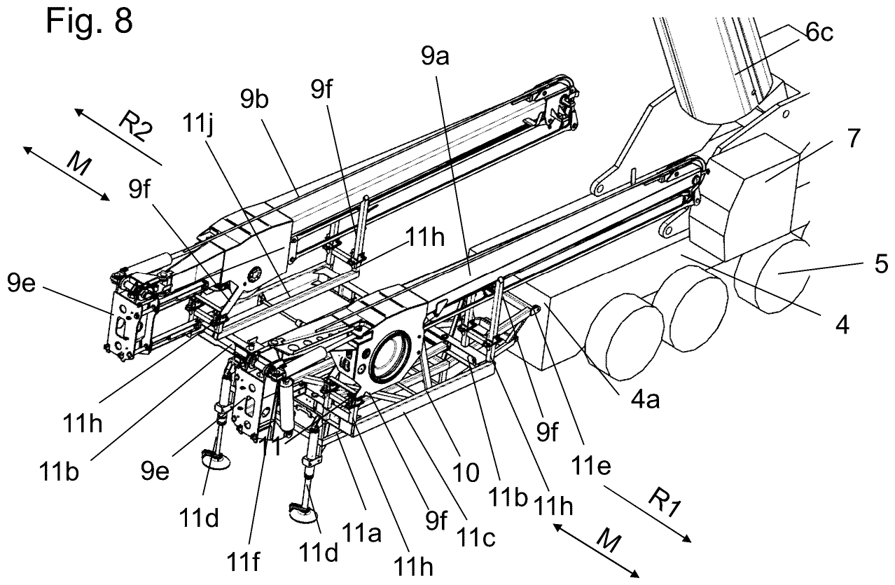

FIG. 8 shows a perspective detailed view of the mounting framework 11 shown in FIG. 4 with a first and a second bracing arm 9a, 9b. Following on from the rigging state shown in FIG. 7, the second bracing arm 9b has been placed on the second sliding frame 11j, the lifting cable 8 has been detached from the second bracing arm 9b and then the second sliding frame 11j has been displaced from its inner/central or left-hand receiving position jointly with the second bracing arm 9b in the second direction R2 to the left outwards to the lowering position. Where required, the same can be performed for the first bracing arm 9a now or even beforehand. Both bracing arms 9a, 9b are now located in the outer lowering positions. If the two bracing arms 9a, 9b are each located in this lateral lowering position, the telescoping jib 6 can be lowered to its substantially horizontal receiving position between the two bracing arms 9a, 9b such that the basic box 6a is oriented on a level with a fastening frame 9e of the first bracing arm 9a.

FIG. 9 illustrates a perspective detailed view of the vehicle crane 2 with the mounting framework 11 and the received, first and second bracing arms 9a, 9b. In comparison with FIG. 8, the telescoping jib 6 is now luffed down to its substantially horizontal receiving position between the first and second bracing arm 9a, 9b. Neither the first bracing arm 9a nor the second bracing arm 9b which are each located in the lowering position hinder the lowering of the basic box 6a to its receiving position. There is sufficient free space, at least 100 mm and at most 1000 mm, preferably 400 mm to 800 mm, available between the basic box 6a and the first bracing arm 9a for lowering purposes. FIG. 9 also shows that the inner boxes 6b have been retracted for the purpose of lowering the telescoping jib 6.

FIG. 9 also shows particularly clearly the arrangement of the mounting framework 11 in extension of the lower carriage 4 of the vehicle crane 2 and completely behind the lower carriage 4. The lower carriage 4 is illustrated in simplified form in a cuboid shape and therefore has a rear end 4a which is oriented substantially vertically to the ground surface U and which can therefore also be referred to as the rear wall. The same applies to a front end of the lower carriage 4, on which a vertical front wall of the lower carriage 4 can be found. Alternatively, the mounting framework 11 could be arranged at this location. The actual fastening of the mounting framework 11 to the lower carriage 4 and thus also an orientation with the lower carriage 4 in the longitudinal direction L and in the height direction are effected via bolt connections 13 which are designed as single-shear or multi-shear bolt connections. Such bolt connections 13 typically consist of lugs with bores on the components to be connected to one another, in this case the lower carriage 4 and the mounting framework 11. For a connection, the lugs are brought into registration with the bores and are connected to one another via a bolt inserted into the bores which are then flush. The lugs are arranged on the one hand on the rear wall of the lower carriage 4 and on the other hand on the four front ends Ile of the mounting framework 11. Accordingly, the mounting framework 11 is then fastened to the lower carriage 4. Therefore, the mounting framework 11 is not supported on a surface or top side of the lower carriage 4 and is arranged completely behind the lower carriage. The mounting framework 11 is supported on the rear end 4a or front end of the lower carriage 4.

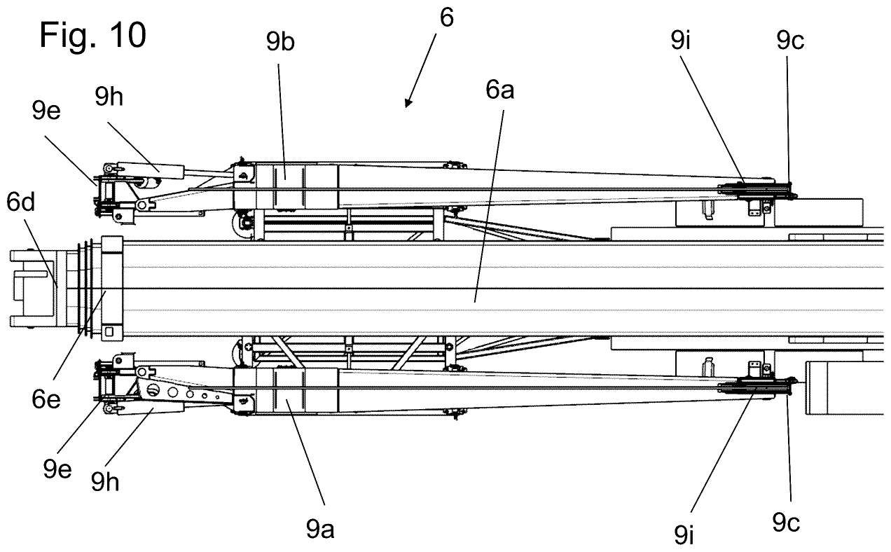

FIG. 10 shows an enlarged section of a plan view of the first bracing arm 9a and the second bracing arm 9b shown in FIG. 8 in each case in the lowering position on the mounting framework 11. In this case, the first bracing arm 9a lies with its fastening frame 9e laterally adjacent to and at a distance from the collar 6e of the basic box 6a of the telescoping jib 6. The same applies to the second bracing arm 9b, wherein, however, this is arranged on the side, opposite the first bracing arm 9a, in relation to the telescoping jib 6. Both bracing arms 9a, 9b in FIG. 10 show a lateral distance from the telescoping jib 6. It is evident that the first bracing arm 9a and also the second bracing arm 9b extend substantially in parallel with the telescoping jib 6 and the respective fastening frames 9e are arranged, as seen in the side view, in front of the collar 6e of the basic box 6a.

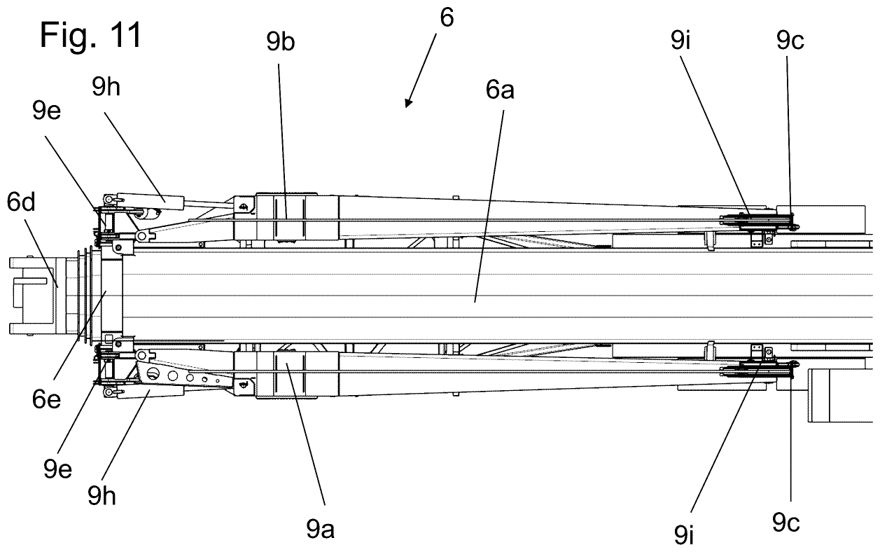

FIG. 11 shows an enlarged section shown in FIG. 10 with the first bracing arm 9a and the second bracing arm 9b shown in each case in the fastening position. For this purpose, the first sliding frame 11c and also the second sliding frame 11j are each displaced from their lowering position together with the first bracing arm 9a and second bracing arm 9b respectively inwards onto the basic box 6a and so the fastening frame 9e comes to abut against the collar 6e of the basic box 6a. Then, the two sliding frames 11c, 11j are each located with the first bracing arm 9a and the second bracing arm 9b in the central fastening position. Subsequently, the first bracing arm 9a and also the second bracing arm 9b are fastened, in particular bolted, to the basic box 6a. Then, the first bracing arm 9a and also the second bracing arm 9b are picked up from the mounting framework 11 by luffing the telescoping jib 6 up.

FIG. 12 shows a perspective view of the vehicle crane 2 with its bracing apparatus 9 with the two attached bracing arms 9a, 9b in the operating state. After the two bracing arms 9a, 9b have been attached to the telescoping jib 6 as described above, the bracing arms 9a, 9b are erected and braced in a known manner. For this purpose, in a first step, bracing cables 12a are each guided from the tensioning mechanism 9d via a deflection roller 9i arranged on a tip 9c of the respective bracing arm 9a, 9b (see FIG. 9) to the telescoping jib head 6d where they are fastened. Then, in a further step a plurality of bracing rods 12b arranged one behind the other are arranged between the telescoping jib foot 6c and the tip 9c of the respective bracing arm 9a, 9b. Instead of bracing rods 12b, cables or chains or combinations thereof including the bracing rods 12b can also be used. The tensioning mechanism 9d is arranged below each of the bracing arms 9a, 9b and, starting from the centre of the longitudinal extension of the bracing arms 9a, 9b, in a manner offset in the direction of the fastening frame 9c. As previously described, the fastening frame 9e serves to fasten the bracing arm 9a, 9b to the basic box 6a. The fastening frame 9e also comprises a double joint in order to erect the respective bracing arm 9a, 9b relative to the basic box 6a by means of an erecting cylinder 9g, arranged between the fastening frame 9e and the bracing arm 9a, 9b, and in order to be able to pivot said bracing arm laterally to the V-position by means of a pivoting cylinder 9h arranged between the fastening frame 9e and the bracing arm 9a, 9b. Subsequently, the telescoping jib 6 is luffed up together with the two bracing arms 9a, 9b. The two bracing arms 9a, 9b are then set up from their transport position almost in parallel with the telescoping jib 6 by means of the erecting cylinders 9g relative to the telescoping jib 6 and the two bracing arms 9a, 9b are splayed in a v-shape by means of the pivoting cylinders 9h. The two bracing arms 9a, 9b are thus oriented approximately orthogonally to the basic box 6a and form an angle of about 60 degrees with respect to one another. The bracing rods 12b are tensioned by the actions of erecting and pivoting-out. The bracing cables 12a are tensioned in parallel via the tensioning mechanisms 9d. Where required, the inner boxes 6b can be extended and the bracing cables 12a can be adjusted and tensioned via the tensioning mechanisms 9d. The bracing cables 12a or bracing rods 12b can also be connected to an additional counterweight. Such bracing apparatuses 9 can also be referred to as a Sideways Super-lift, SSL.

In a step concluding the rigging procedure, the lifting cable 8 is then attached to the mounting framework 11, the mounting framework 11 is detached from the lower carriage 4 and temporarily stored by the vehicle crane 2 at a suitable location or on the second transport unit 3b for subsequent dismounting of the two bracing arms 9a, 9b.

The bracing apparatus 9 is dismounted from the telescoping jib 6 in the reverse sequence.

Changes and modifications in the specifically described embodiments can be carried out without departing from the principles of the present invention which is intended to be limited only by the scope of the appended claims, as interpreted according to the principles of patent law including the doctrine of equivalents. The priority German application no. DE 10 2023 119 813.0, filed on Jul. 26, 2023, is hereby incorporated by reference, in particular for support with regard to the translation for the present disclosure.

1. A vehicle crane comprising:
a lower carriage;
a mounting framework comprising at least one displaceable sliding frame;
a bracing apparatus;
wherein at least one bracing arm of the bracing apparatus can be temporarily stored on the mounting framework, and wherein a single bracing arm can be temporarily stored on the sliding frame, and wherein the mounting framework is arranged in extension of the lower carriage of the vehicle crane and completely behind the lower carriage and is fastened to the lower carriage.

2. The vehicle crane as claimed in claim 1, wherein the mounting framework is supported on a ground surface via support legs at a rear end of the mounting framework remote from the lower carriage and is coupled, at an opposite front end, to a rear end of the lower carriage.

3. The vehicle crane as claimed in claim 1, wherein the at least one displaceable sliding frame comprises a first sliding frame and a second sliding frame, and wherein the mounting framework further comprises a base frame and an intermediate frame, wherein the intermediate frame is arranged on the base frame and the first and second sliding frames are arranged on the intermediate frame in such a manner as to be displaceable independently of one another.

4. The vehicle crane as claimed in claim 3, wherein, starting from a completely retracted receiving position, the first sliding frame can be displaced only in a first direction and can be displaced back again and, starting from a completely retracted receiving position, the second sliding frame can be displaced in a second direction opposite to the first direction and can be displaced back again.

5. The vehicle crane as claimed in claim 4, wherein the vehicle crane further comprises a superstructure and a telescoping jib, wherein the telescoping jib comprises a basic box with retractable and extendible inner boxes, and wherein the bracing apparatus comprises a first bracing arm and a second bracing arm and can be attached to the telescoping jib and, for attachment purposes, the first bracing arm and the second bracing arm can be placed on the mounting framework one after the other.

6. The vehicle crane as claimed in claim 2, wherein the at least one displaceable sliding frame comprises a first sliding frame and a second sliding frame, and wherein the mounting framework further comprises a base frame and an intermediate frame, wherein the intermediate frame is arranged on the base frame and the first and second sliding frames are arranged on the intermediate frame in such a manner as to be displaceable independently of one another.

7. The vehicle crane as claimed in claim 6, wherein, starting from a completely retracted receiving position, the first sliding frame can be displaced only in a first direction and can be displaced back again and, starting from a completely retracted receiving position, the second sliding frame can be displaced in a second direction opposite to the first direction and can be displaced back again.

8. The vehicle crane as claimed in claim 7, wherein the vehicle crane further comprises a superstructure and a telescoping jib, wherein the telescoping jib comprises a basic box with retractable and extendible inner boxes, and wherein the bracing apparatus comprises a first bracing arm and a second bracing arm and can be attached to the telescoping jib and, for attachment purposes, the first bracing arm and the second bracing arm can be placed on the mounting framework one after the other.

9. A vehicle crane comprising:
a lower carriage;
a superstructure arranged on the lower carriage;
a telescoping jib carried by the superstructure and comprising a basic box with retractable and extendible inner boxes;
a mounting framework comprising at least one displaceable sliding frame; and
a bracing apparatus comprising a first bracing arm and a second bracing arm;
wherein at least one of the first bracing arm and the second bracing arm can be temporarily stored on the mounting framework, and wherein a single one of the first bracing arm and the second bracing arm can be temporarily stored on the sliding frame, and wherein the mounting framework is arranged in extension of the lower carriage and completely behind the lower carriage and is fastened to the lower carriage;
wherein the bracing apparatus is configured to be attached to the telescoping jib and, for attachment purposes, the first bracing arm and the second bracing arm can be placed on the mounting framework one after the other.

10. The vehicle crane as claimed in claim 9, wherein the mounting framework is supported on a ground surface via support legs at a rear end of the mounting framework remote from the lower carriage and is coupled, at an opposite front end, to a rear end of the lower carriage.

11. The vehicle crane as claimed in claim 10, wherein the at least one displaceable sliding frame comprises a first sliding frame and a second sliding frame, and wherein the mounting framework further comprises a base frame and an intermediate frame, wherein the intermediate frame is arranged on the base frame and the first and second sliding frames are arranged on the intermediate frame in such a manner as to be displaceable independently of one another.

12. The vehicle crane as claimed in claim 11, wherein, starting from a completely retracted receiving position, the first sliding frame can be displaced only in a first direction and can be displaced back again and, starting from a completely retracted receiving position, the second sliding frame can be displaced in a second direction opposite to the first direction and can be displaced back again.

13. A method for mounting a bracing apparatus on a telescoping jib of a vehicle crane comprising:
providing a first transport unit having a mounting framework, received thereon, in the region of the vehicle crane;
raising the mounting framework from the first transport unit via the vehicle crane;
positioning the mounting framework in extension of a lower carriage of the vehicle crane;
fastening the mounting framework to a lower carriage and completely behind the lower carriage and detaching the vehicle crane from the mounting framework;
providing a second transport unit having a bracing apparatus, which is received thereon and includes a first bracing arm and a second bracing arm, in the region of the vehicle crane;
raising the first bracing arm from the second transport unit via the vehicle crane;
lowering and placing the first bracing arm of the bracing apparatus onto a first sliding frame of the mounting framework via the vehicle crane;
displacing the first sliding frame in a first direction of a mounting direction from a retracted receiving position to a laterally extended lowering position;
raising the second bracing arm from the second transport unit via the vehicle crane;
lowering and placing the second bracing arm of the bracing apparatus onto a second sliding frame of the mounting framework via the vehicle crane;
displacing the second sliding frame in a second direction of the mounting direction from a retracted receiving position to a laterally extended lowering position;
luffing the telescoping jib down between the first bracing arm and the second bracing arm;
displacing the first sliding frame and the second sliding frame in each case in the mounting direction from its lowering position to a central fastening position, in which in each case a fastening frame of the first bracing arm and the second bracing arm abut against a basic box of the telescoping jib; and
fastening the first bracing arm and the second bracing arm with its fastening frame to the basic box.
